(19) United States
(12) Patent Application Publication
(10) Pub. No.: US 2026/0087037 A1
(43) Pub. Date: Mar. 26, 2026

(54) DYNAMICALLY UPDATING GENERATED SUBQUERIES

(71) Applicant: NeuBird Inc., San Mateo, CA (US)

(72) Inventors: Goutham Rao, San Mateo, CA (US); Vinod Jayaraman, San Mateo, CA (US)

(73) Assignee: NeuBird Inc., San Mateo, CA (US)

(21) Appl. No.: 19/314,761

(22) Filed: Aug. 29, 2025

Related U.S. Application Data
(60) Provisional application No. 63/698,807, filed on Sep. 25, 2024.

(51) Int. Cl. G06F 16/3329; G06F 16/2453

(52) U.S. Cl. CPC G06F 16/3329; G06F 16/24535

(57) ABSTRACT

Methods and apparatus for dynamically updating subqueries for IT Operations (Ops) are provided. When an IT administrator query is received, a system generates multiple subqueries based on the IT administrator query. As responses to initial subqueries are generated, subsequent subqueries are dynamically modified and updated based on the results of previously executed subqueries. This dynamic subquery updating process allows the system to refine its analysis approach in real-time. In various embodiments, an LLM leverages telemetry data from disparate IT platforms including logs, alerts, infrastructure configurations, and traces that are dynamically schematized into a structured database. The iterative subquery modification process enhances diagnostic accuracy and provides for more targeted troubleshooting by continuously adjusting the query strategy based on emerging insights.

### TECHNICAL FIELD

This disclosure generally relates to Information Technology (IT) and Large Language Models (LLMs), and more specifically to dynamic subquery generation for IT Generative Operations (GenOps) .

### BACKGROUND

Observability and monitoring in IT operations (IT Ops) are becoming increasingly costly and resource intensive due to a number of factors including the complexity of IT environments, vast amounts of data, stringent service level agreements (SLAs), security requirements, and skilled personnel shortages. IT Ops spend now makes up a substantial part of enterprise IT spending.

Some efforts have been made to develop automated tools for monitoring increasingly complex IT environments. Some of these tools may be specific to particular inhouse or cloud IT platforms, such as Amazon Web Services (AWS), Microsoft Azure, VMWare, MangoDB Atlas, Prometheus, etc. Other efforts have been made to leverage open-source solutions, to reduce the number of IT platforms, or to unify particular sets of services or consolidate monitoring tools. Each of these approaches can decrease the cost of IT Ops, but have a variety of drawbacks and limitations. Consequently, there is a persistent need to enhance and improve IT Ops.

### BRIEF DESCRIPTION OF THE DRAWINGS

FIG. 1 illustrates an example of a system for IT operations (IT Ops).

FIG. 2 illustrates an example of a system for IT Generative Operations (IT GenOps).

FIG. 3A illustrates an example of a system for IT GenOps having access to disparate IT platforms and associated IT data sources.

FIG. 3B illustrates an example of cognitive views for IT Telemetry.

FIG. 4A illustrates an example of subquery generation.

FIG. 4B illustrates an example of dynamic updates of subqueries.

FIG. 4C illustrates one example of a subquery generation user interface/user experience (UI/UX)

FIG. 5 illustrates an example of IT GenOps and a Virtual Private Cloud (VPC).

FIG. 6 illustrates an example of a IT GenOps interface.

FIG. 7A illustrates an example of an IT GenOps suggested resolution.

FIG. 7B illustrates an example of an IT GenOps real-time solution.

FIG. 8 illustrates one example of a computing device.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of IT Ops. However, it should be noted that the techniques of the present invention apply to a wide variety of different environments. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, observability may include a variety of specific metrics. However, it will be appreciated that a system can use variety of different types of data while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, different layers may be connected using a variety of mechanisms. Consequently, a connection does not necessarily mean a direct, unimpeded connection unless otherwise noted.

Current observability and monitoring practices have become exceedingly complex due to the multitude of data sources that need to be managed. These data sources may be inhouse platforms as well as disparate cloud IT platforms such as Amazon Web Services (AWS), Microsoft Azure, Google Cloud, IBM Cloud, Splunk, MangoDB Atlas, Snowflake Data Cloud, Elasticsearch, Redis, Influx, Prometheus, VMWare, etc. These disparate IT platforms or data sources may include IT telemetry data associated with logs, traces, metrics, alerts, system configurations, and infrastructure configurations, etc., providing critical insights into different aspects of IT operations. However, the sheer volume and variety of data can create significant challenges in terms of data extraction, loading, analysis, and visualization.

Firstly, data from these disparate IT platforms must be extracted and loaded into an analytics database. This extraction and loading process sometimes referred to as ETL (extract, transform, load), is resource-intensive and time-consuming. It requires specialized tools and processes to ensure data is correctly ingested without loss or corruption. Managing the ETL pipeline effectively demands substantial IT resources.

Custom and often complex queries are required to derive meaningful insights from the data once the data has been loaded into a database. Setting up dashboards and visualizations to present data effectively is another layer of complexity.

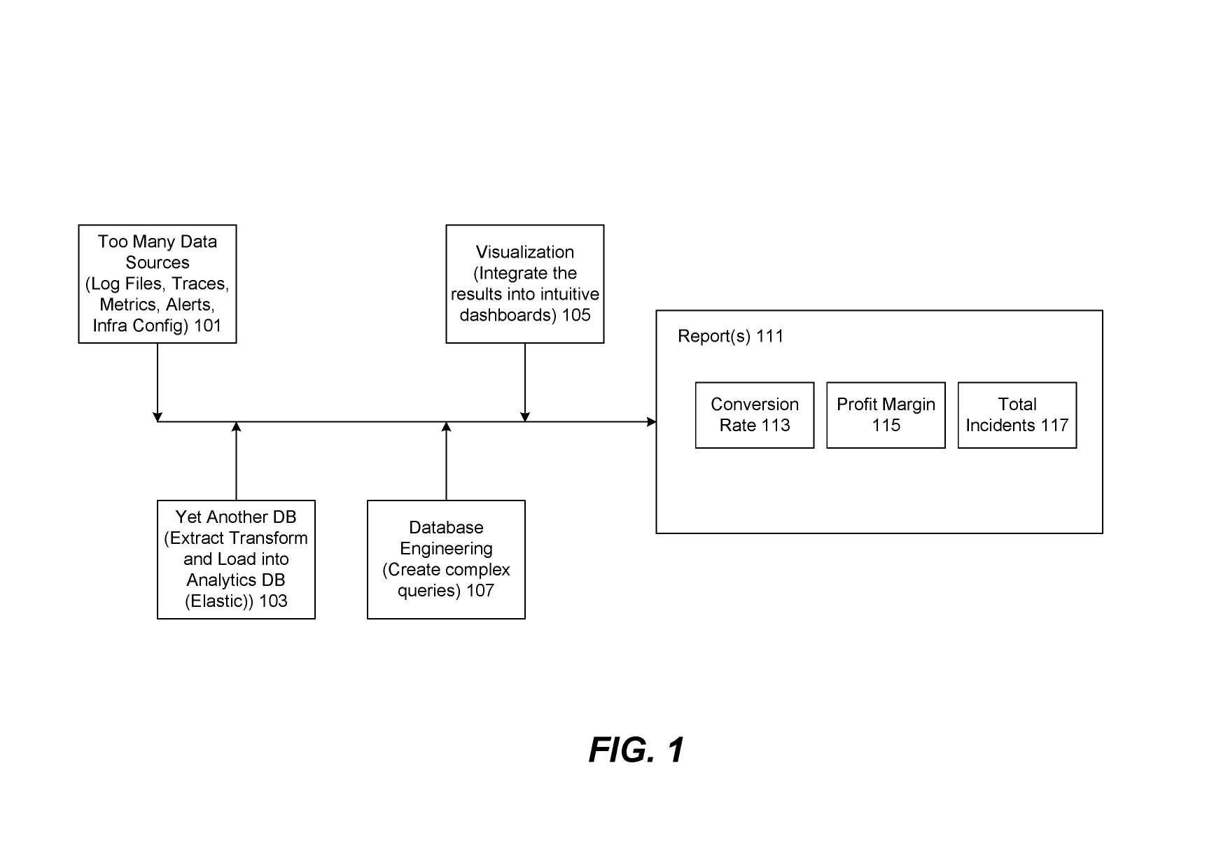

FIG. 1 is a diagrammatic representation illustrating an example of IT Ops inefficiency. According to various embodiments, the end-to-end cycle from data extraction to visualization is not only time-consuming but also continuous and iterative. In particular embodiments, data sources 101 provide telemetry information that flows with information from additional DBs 103, and database engineering component 107. According to various embodiments, as new data flows in, the ETL pipelines need to be updated, queries must be adjusted, and dashboards modified through visualization component 105. In particular examples, this perpetual cycle consumes significant time and resources, leading to reports 111 that include metrics such as conversion rate 113, profit margin 115, and total incidents 117, while leaving IT teams in a constant state of catch-up rather than proactive management. It should be noted that Site Reliability Engineering (SRE) is sometimes referred to as a different area overlapping IT Ops. SRE generally focuses on reliability, scalability, and automation. However, as used herein, IT Ops encompasses SRE.

Moreover, according to various embodiments, the fragmented nature of the process handling multiple tools for extraction adds to the inefficiency. In particular embodiments, each tool might require different expertise, and ensuring seamless integration between them can be challenging. In particular examples, this fragmentation often leads to delays and potential data discrepancies, reducing the overall effectiveness of the observability and monitoring efforts reflected in reports 111.

According to various embodiments, the current observability and monitoring landscape is hindered by the complexity and volume of data sources 101. In particular embodiments, the process of extracting, loading, analyzing, and visualizing data is labor-intensive and iterative, making it inefficient and time-consuming. According to various embodiments, Large Language Models (LLMs) can significantly enhance observability and monitoring in IT environments by providing IT operators with an intuitive and powerful tool for diagnosing issues.

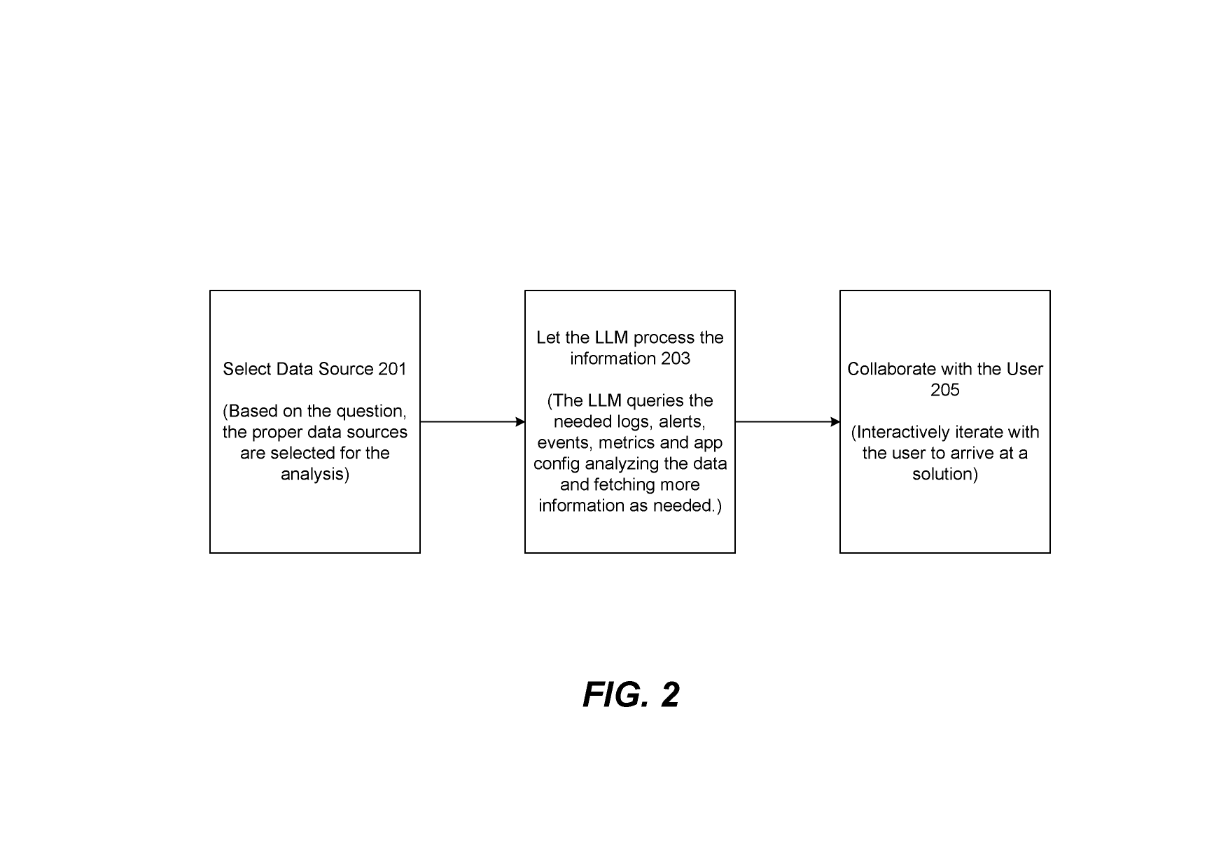

FIG. 2 is a diagrammatic representation illustrating one example of use of an LLM in IT Ops. Use of LLMs in IT Ops is generally referred to herein as IT GenOps. According to various embodiments, the process begins with select data source 201, where LLMs can process and analyze vast amounts of data from diverse sources, such as logs, metrics, traces, and configuration files, in real-time. In particular embodiments, allow the LLM to process the information 203 enables IT operators to interact with these models using natural language, asking questions to pinpoint issues, identify patterns, and derive insights through collaborate with the user 205.

According to various embodiments, an IT environment may include a variety of IT environment components such as a Relational Database Service (RDS) component, a container orchestration platform component, and a storage management platform component. In particular embodiments, the IT environment components may be associated with a variety of IT platforms such as AWS, Google Cloud, VMWare, and Prometheus, as well as associated data sources such as RDS transaction logs and system state logs, container deployment data, pod statuses, and storage performance, capacity, and throughput metrics. According to various embodiments, this collected data from select data source 201 is then integrated into a centralized analytics platform where it undergoes preprocessing, including data cleaning and normalization through allow the LLM to process the information 203. In particular examples, advanced analytics techniques, such as machine learning algorithms and statistical analysis, are applied to identify patterns, correlations, and anomalies.

According to various embodiments, for instance, an operator might ask an LLM through collaborate with the user 205 to identify the cause of a spike in CPU usage or to trace the source of an error across microservices. In particular embodiments, rather than executing a predetermined set of static queries, the LLM dynamically generates an initial set of subqueries and then adaptively modifies subsequent subqueries based on the results of earlier investigations. According to various embodiments, if the first subquery reveals that CPU spikes correlate with specific API endpoints, the LLM automatically updates remaining subqueries to focus on those endpoints rather than executing irrelevant queries about unrelated system components. In particular examples, this dynamic subquery adaptation enables the system to pursue the most promising diagnostic paths while abandoning unproductive lines of inquiry in real-time, significantly accelerating problem resolution compared to traditional static query approaches.

According to various embodiments, despite their potential, LLMs also present several challenges, notably the issue of "hallucinations," where the model generates incorrect or misleading information that appears plausible. In particular embodiments, LLM hallucinations occur because these models, while powerful, do not possess true understanding or factual verification mechanisms. According to various embodiments, they generate responses based on patterns in the data they were trained on, which can lead to confidently stated inaccuracies. In particular examples, LLMs require substantial computational resources for both training and operation, making them expensive and energy-intensive. According to various embodiments, they can also be opaque in their decision-making processes, making it difficult to understand how a particular response was generated. In particular embodiments, this lack of transparency can be problematic in critical IT operations where traceability and accountability are essential. According to various embodiments, furthermore, LLMs are trained on vast datasets that may contain biased or inappropriate content, which can lead to biased outputs or the reinforcement of harmful stereotypes. In particular examples, ensuring data privacy and security is another concern, as these models can potentially expose sensitive information if not properly managed.

According to various embodiments, Retrieval Augmented Generation (RAG) is an approach in natural language processing that combines the strengths of retrieval-based and generation-based models to produce more accurate and contextually relevant responses. In particular embodiments, in RAG, a retrieval component first searches a large corpus of documents or data to find the most relevant pieces of information related to a given query. According to various embodiments, these retrieved documents then serve as an additional context for a generative model, which uses them to generate a coherent and informative response. In particular examples, the model cross-references generated content with verified data sources to improve factual accuracy.

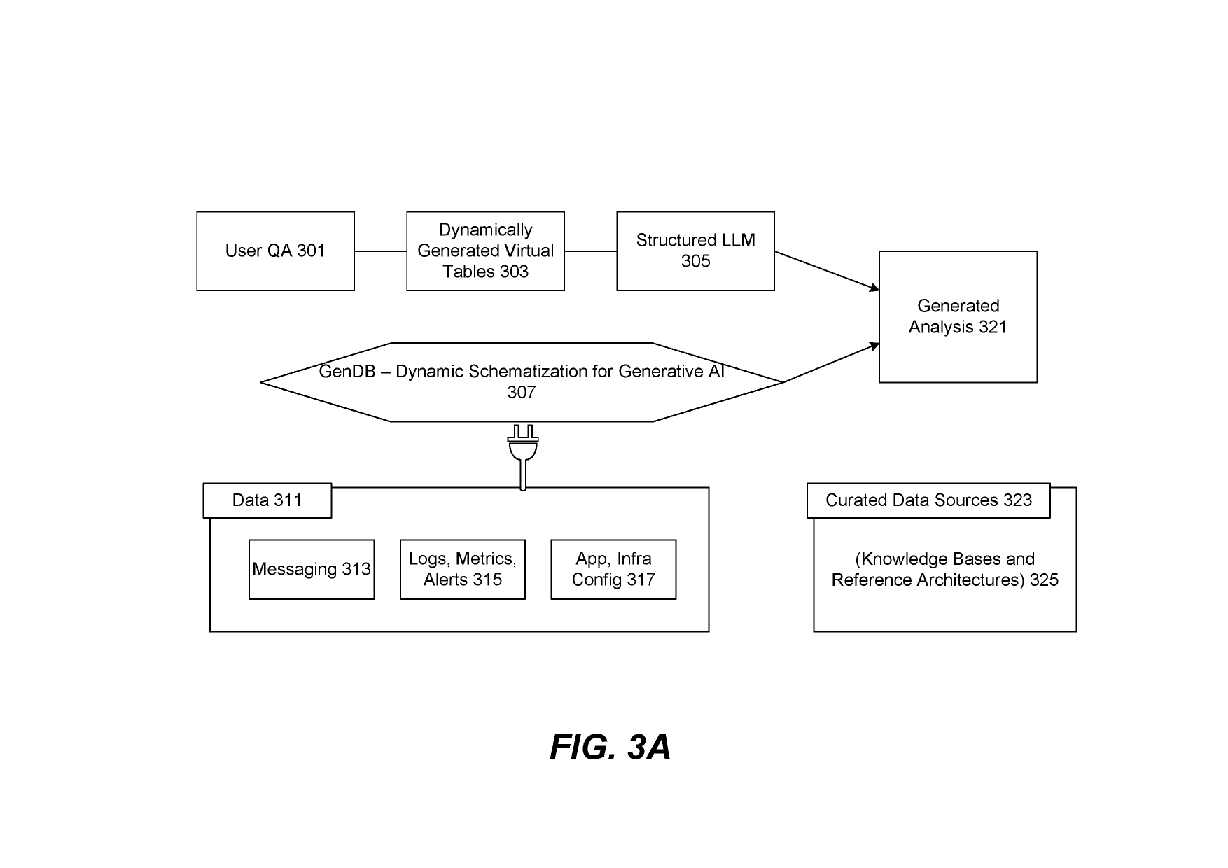

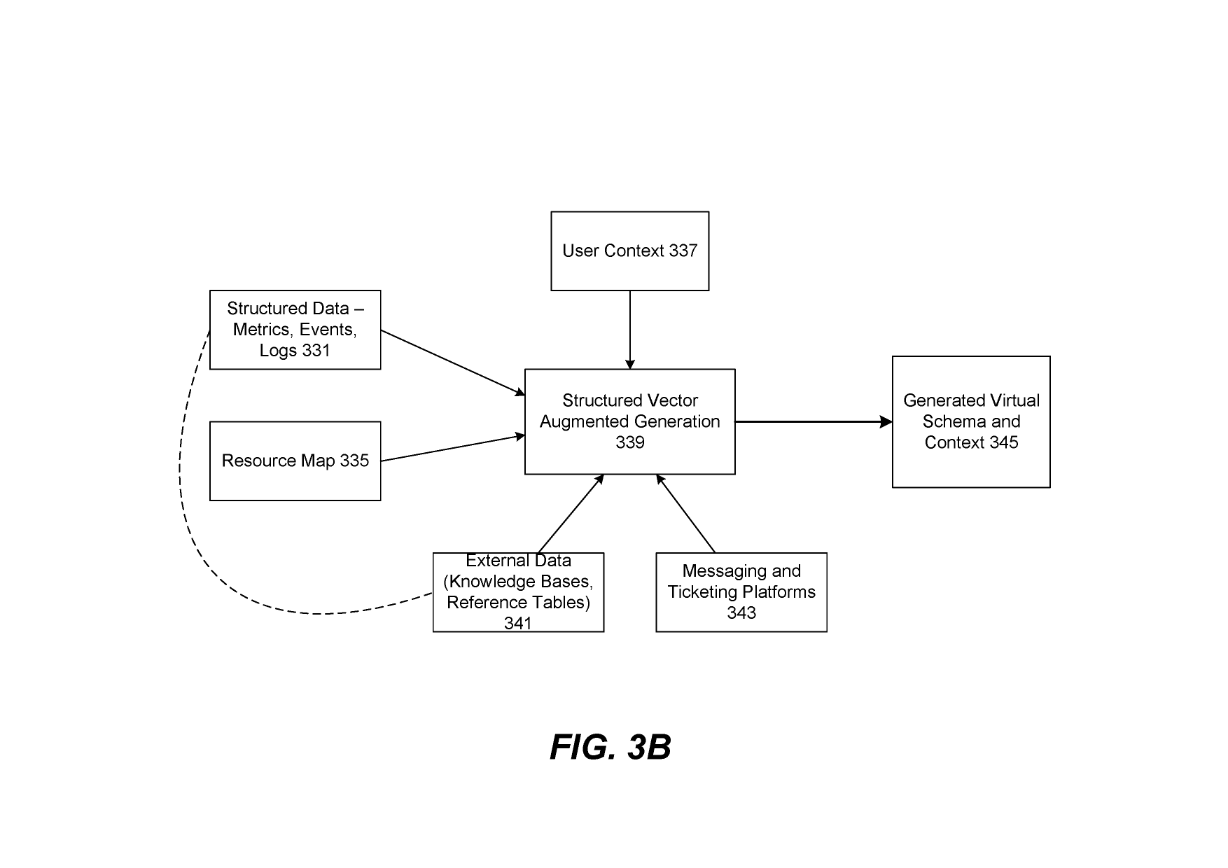

FIG. 3A is a diagrammatic representation illustrating an example of dynamic schematization for IT GenOps. According to various embodiments, User QA 301 is received as a user query. In particular embodiments, the user query may regard why a particular site is slow to respond, or why particular alerts or errors have been detected in a network. According to various embodiments, telemetry data is aggregated from various IT platforms such as Amazon Web Services (AWS) CloudWatch, AWS CloudTrail, Microsoft Azure, Google Cloud, and VMware by collecting and unifying diverse data types into a cohesive, dynamic structure. In particular embodiments, telemetry data is selected in response to an IT administrator query through User QA 301.

According to various embodiments, metrics, logs, traces, alerts, configuration data, and other data gathered from sensors, software applications, firmware, and hardware components that provides real-time insights in the operational status of an IT environment is referred to herein as telemetry data. In particular examples, by continuously capturing metrics such as CPU usage, memory consumption, network throughput, error rates, and application performance, telemetry data enables IT professionals to proactively identify issues, optimize performance, and provide system reliability.

In particular embodiments, telemetry data from disparate sources is ingested as Data 311. According to various embodiments, each type of data, whether it's a JSON log from Google Cloud, a CloudWatch metric, or a VMware alert, is parsed and normalized into a standard format. In particular embodiments, this includes messaging 313, log/metrics/alerts 315, and app and infra conFIG. 317 as dynamically schematized for generative AI at 307. According to various embodiments, this normalized data is then stored in dynamically generated virtual tables 303, which allow for flexible and scalable schema generation. In particular examples, these virtual tables are designed to adapt to the varying structures and schemas of the incoming data, providing a unified view for querying and analysis.

According to various embodiments, it is recognized that Foreign Data Wrappers (FDWs) such as PostgreSQL FDWs are a particularly powerful tool for aggregating and managing diverse data types from disparate IT platforms and environments, making it easier to generate dynamically generated virtual tables 303 and create an IT telemetry structure database. In particular embodiments, FDWs allow a database to interface with external data sources as if they were regular database tables. According to various embodiments, by utilizing FDWs, data from AWS CloudWatch, AWS CloudTrail, JSON logs, Microsoft Azure, Google Cloud, and VMware can be seamlessly integrated into a unified PostgreSQL database. In particular examples, each data source can be accessed through a corresponding FDW, enabling real-time querying and manipulation. According to various embodiments, JSON logs from Google Cloud can be parsed and queried directly, while metrics from AWS CloudWatch can be monitored alongside configuration data from VMware. In particular embodiments, this integration simplifies data management by centralizing access to multiple data formats and sources within a single relational database. According to various embodiments, consequently, creating dynamically generated virtual tables 303 becomes more efficient, as FDWs allow for on-the-fly schema generation and transformation. In particular examples, this approach streamlines the process of building a comprehensive IT telemetry structure, providing a unified view and enhancing the ability to perform in-depth analysis and monitoring across a complex IT environment.

According to various embodiments, curated data sources 323 such as IT knowledge bases and reference architectures 325 can be incorporated into enterprise IT GenOps. In particular embodiments, knowledge bases provide a repository of domain-specific information, including best practices, troubleshooting guides, and comprehensive documentation, which can be integrated into structured LLM 305 to improve its contextual understanding and response accuracy. According to various embodiments, reference architectures offer standardized templates and blueprints for IT systems, providing a well-defined structure for interpreting and implementing various technologies and solutions. In particular examples, by including these curated data sources 323 along with only actual schematized telemetry data provided by an enterprise, structured LLM 305 can offer more structured and relevant insights for generated analysis 321. According to various embodiments, data not provided by an enterprise remains private and is not exposed to any outside networks.

FIG. 3B illustrates one example of structured vector augmented generation 339. According to various embodiments, structured vector augmented generation 339 of a virtual schema and context involves creating a dynamic and highly contextualized data model that integrates various sources of information to provide comprehensive insights. In particular embodiments, this process begins with the ingestion of user context 337, which includes specific queries, user roles, and relevant historical interactions. According to various embodiments, the system then incorporates structured data (metrics, events, logs) 331 from IT telemetry metrics, events, alerts, logs, and infrastructure configurations, offering a detailed view of the current state of the IT environment. In particular examples, resource map 335 is used to understand the relationships and dependencies between different components within the infrastructure.

In particular embodiments, external data (knowledge bases, reference tables) 341, such as knowledge bases and reference tables, are integrated to enrich the context with domain-specific information and best practices. According to various embodiments, messaging and ticketing platforms 343 contribute by adding real-time communication and incident management data, ensuring that the model reflects the latest operational status and user interactions. In particular embodiments, by using structured vector representations to encode this diverse information through structured vector augmented generation 339, the system generates generated virtual schema and context 345 that dynamically adapts to the evolving context.

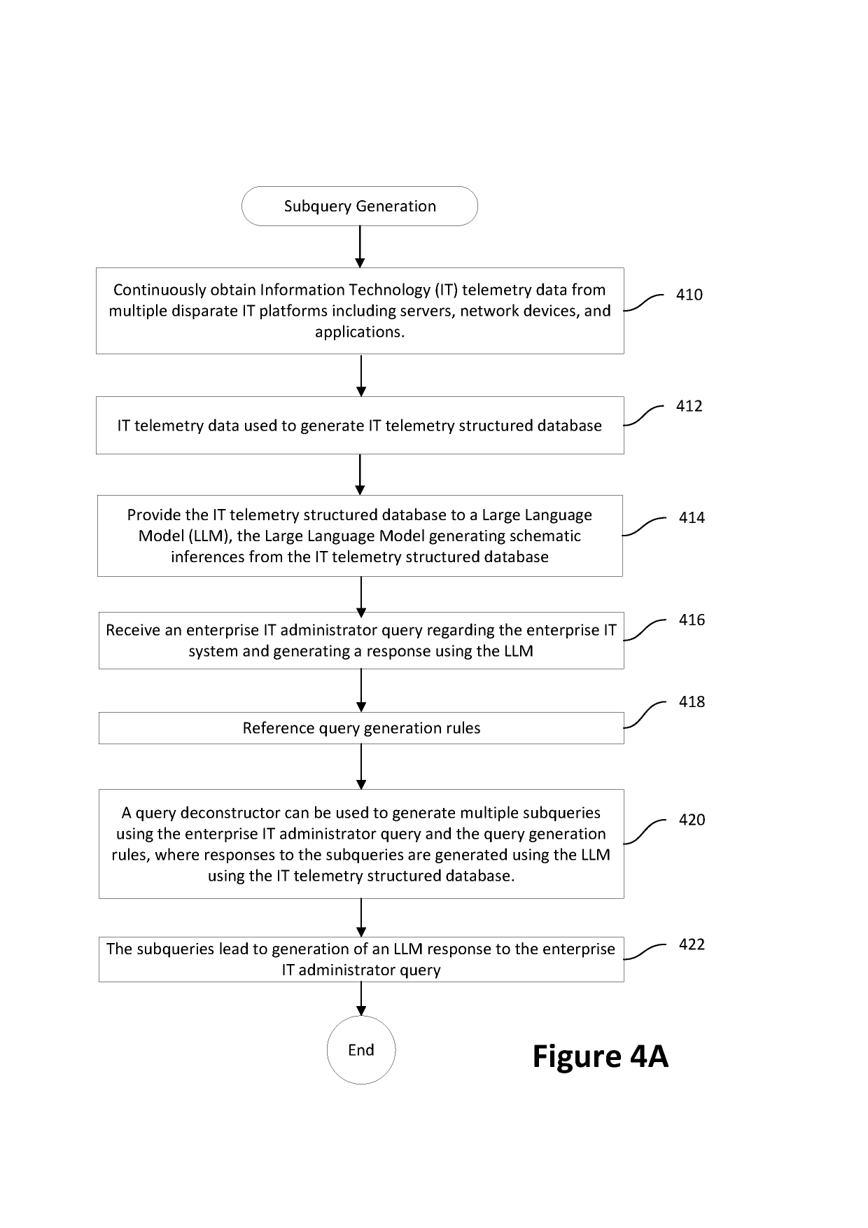

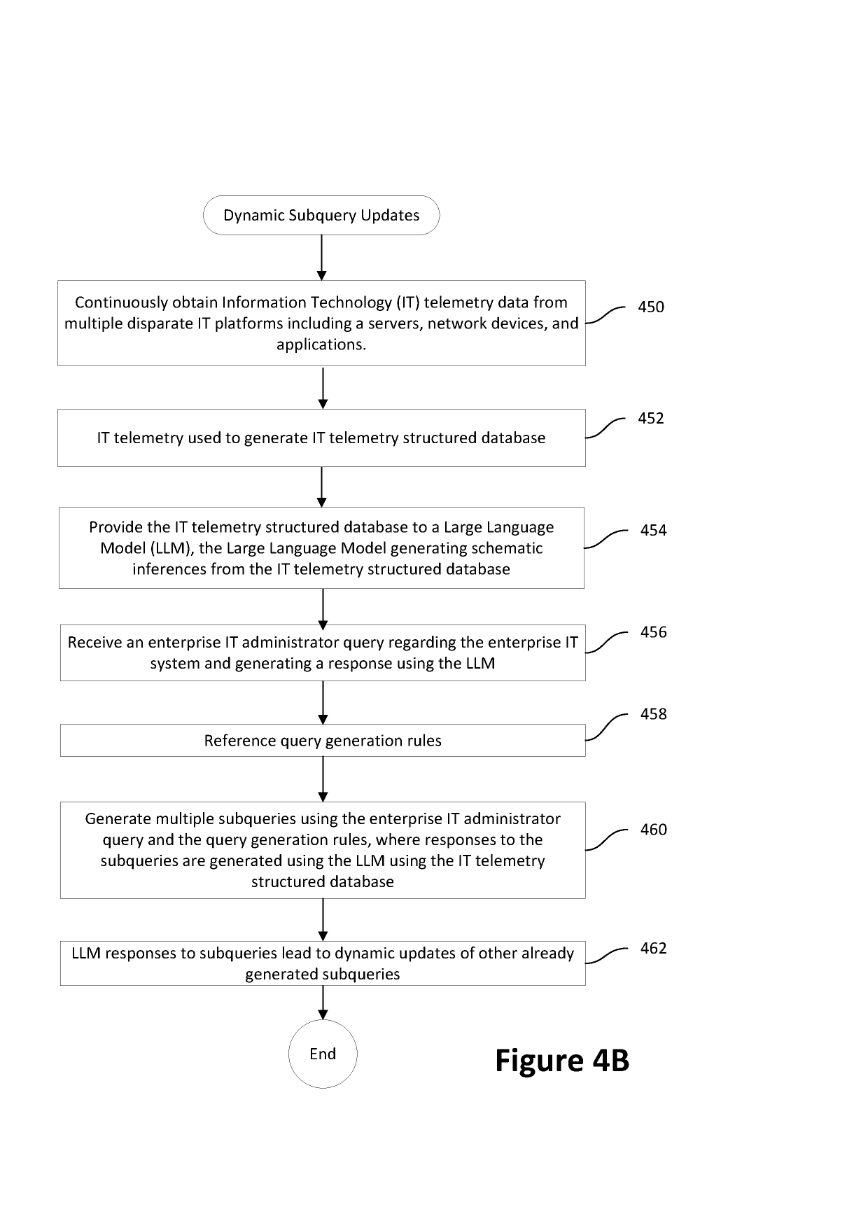

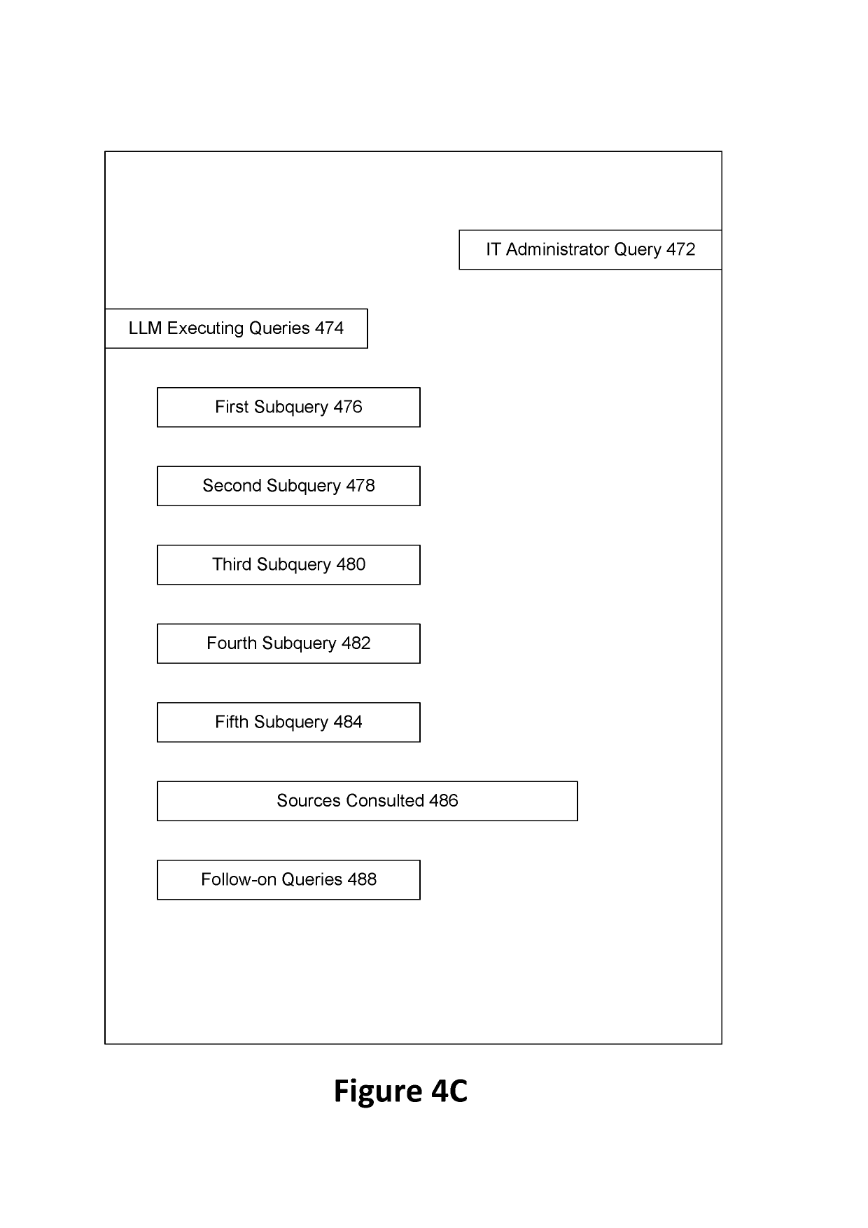

FIG. 4A illustrates an example of subquery generation. According to various embodiments, Information Technology (IT) telemetry data is continuously obtained at 410 from multiple disparate IT platforms including multiple servers, network devices, and applications, the IT telemetry data associated with log files, system traces, metrics, alerts, and infrastructure configurations for monitoring and troubleshooting an enterprise IT system. The IT telemetry data is used to create an IT telemetry structured database at 412. In particular embodiments, the IT telemetry structured database is provided at 414 to an IT GenOps Large Language Model (LLM). The LLM generates multiple schematic inferences from the IT telemetry structured database.

According to various embodiments, an enterprise IT administrator query regarding the enterprise IT system is received at 416. In particular embodiments, a response is generated using the LLM. At 418, multiple query generation rules can be referenced. According to various embodiments, query generation rules may include using only provided schemas, selecting only columns explicitly listed in the schema of the table, checking all columns against the schema to provide that they exist in the tables being queried, adding explicit casts for aggregator functions/timestamps, providing only a query string without markdown or comments, etc.

According to various embodiments, a query deconstructor analyzes the enterprise IT administrator query to identify semantic components, data dependencies, and logical relationships before multiple subqueries are generated at 420 using the enterprise IT administrator query and the plurality of query generation rules. In particular embodiments, the query deconstructor employs natural language processing techniques to parse the administrator's intent, extract key entities such as system components, time ranges, and performance metrics, and map these entities to corresponding database schemas within the IT telemetry structured database. According to various embodiments, the query deconstructor determines the optimal sequence and prioritization of subqueries by analyzing data relationships and dependencies between different IT system components. In particular examples, if an administrator query asks "why is the payment service slow today," the query deconstructor identifies that this requires subqueries examining payment service performance metrics, upstream dependencies, network latency, database response times, and recent configuration changes. According to various embodiments, the query deconstructor also applies contextual filtering based on the administrator's role, access permissions, and historical query patterns to provide generated subqueries are both relevant and authorized. In particular embodiments, responses to the multiple subqueries are generated by the LLM using the IT telemetry structured database, with the query deconstructor coordinating the integration of subquery results to synthesize a coherent response. According to various embodiments, the multiple subqueries lead to generation of an LLM response to the main enterprise IT administrator query at 422, where the query deconstructor provides logical consistency and completeness across all response components.

FIG. 4B illustrates an example of dynamic subquery updates. According to various embodiments, Information Technology (IT) telemetry data from multiple different IT platforms including servers, network devices, and applications is continuously obtained at 450. The IT telemetry data may be associated with log files, system traces, metrics, alerts, and infrastructure configurations for monitoring and troubleshooting an enterprise IT system such as a datacenter or server farm. The IT telemetry data may be used to generate an IT telemetry structured database at 452. In particular embodiments, an IT telemetry structured database is provided to a Large Language Model (LLM) at 454. According to various embodiments, the Large Language Model generates multiple schematic inferences from the IT telemetry structured database.

At 456, an enterprise IT administrator query regarding the enterprise IT system is received. The IT administrator query may relate to why network bandwidth is so constricted in a cluster, why an error message keeps appearing in logs, why alarms keep getting triggered, etc. At 458, query generation rules are referenced. According to various embodiments, multiple subqueries are generated using the enterprise IT administrator query and multiple query generation rules at 460. In particular embodiments, responses to the multiple subqueries are generated using the LLM using the IT telemetry structured database.

According to various embodiments, as an LLM generates a response to the first subquery, the system employs sophisticated analysis algorithms to evaluate the relevance and implications of the results for the remaining investigation plan. In particular embodiments, the second and third subqueries are not merely updated but are completely reconceptualized based on the response to the first subquery at 462, with the system potentially discarding entire branches of inquiry that are no longer relevant while generating new subqueries to explore promising leads revealed by earlier results. According to various embodiments, this dynamic updating process continues iteratively, with each subquery response triggering a reevaluation of the entire remaining query strategy. In particular examples, the system may determine that particular previously generated queries are no longer relevant and replace them with entirely new subqueries that target specific anomalies or patterns discovered through earlier analysis, ensuring that computational resources are always focused on the most promising diagnostic paths.

FIG. 4C illustrates one example of a subquery generation user interface/user experience (UI/UX) where subqueries may be dynamically updated. According to various embodiments, an IT administrator query is entered at 472 and appears on the UI/UX. An example of an IT administrator query might be a request to show a plot of any alarms over the past week, or why were there a larger than usual number of API calls yesterday. An IT GenOps LLM may indicate that is executing queries at 474. According to various embodiments, the LLM generates and displays subqueries including first subquery 476, second subquery 478, third subquery 480, fourth subquery 482, and fifth subquery 484. If a main query is have the been any configuration changes in the past two days, a subquery might be what configuration changes were logged in a cloud platform in the past two days, or changes were made to a serverless cloud platform configurations in the past two days.

In particular embodiments, as the LLM answers these subqueries, additional subqueries may be changed dynamically based on these subqueries and subquery responses at 486. Additional follow-on questions 488 may also be generated and updated.

According to various embodiments, the dynamic updating mechanism operates through a feedback loop where subquery responses are analyzed for their diagnostic value and impact on the overall investigation strategy. In particular embodiments, machine learning algorithms evaluate patterns in subquery results to predict which types of follow-up queries are most likely to yield actionable insights, automatically prioritizing high-value investigations while deprioritizing or eliminating low-value query paths. According to various embodiments, this intelligent query evolution process enables the system to converge on root causes more rapidly than traditional approaches, as each iteration becomes increasingly focused on the most relevant system components and potential failure modes. In particular examples, the dynamic subquery generation system maintains a decision tree of investigative paths, continuously pruning unproductive branches while expanding promising ones based on real-time evidence from telemetry data analysis.

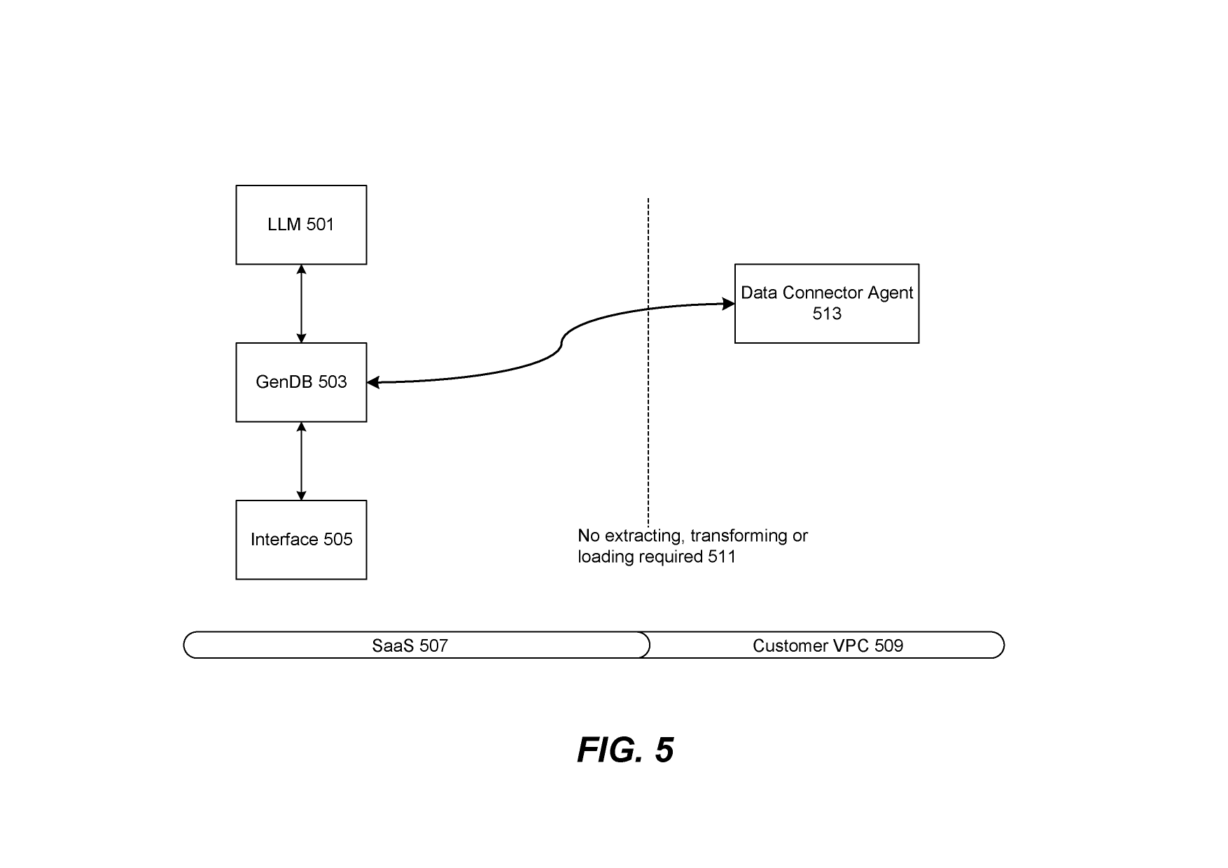

FIG. 5 illustrates one example of integration of a structured LLM with a customer Virtual Private Cloud (VPC). According to various embodiments, a structured IT GenOps Software as a Service (SaaS) 507 Large Language Model (LLM) 501 is connected to a customer Virtual Private Cloud (VPC) 509 using data connector agent 513. In particular embodiments, data connector agent 513 establishes a secure and efficient data transfer pathway between the GenOps LLM 501 and the private network environment of the customer and can be deployed within customer VPC 509. According to various embodiments, data connector agent 513 provides that data transfer complies with security policies and encryption standards, protecting sensitive information during transit. In particular examples, it can handle authentication and authorization, ensuring that only approved data and commands pass between the GenOps LLM 501 and customer VPC 509 through interface 505, where no extracting, transforming, or loading is required at the interface at 511.

According to various embodiments, this structured approach reduces the risk of LLM hallucinations by using cognitively generated insights from dynamically schematized telemetry data stored in GenDB 503 and knowledge and architectural frameworks to deliver coherent, practical, and actionable advice. In particular embodiments, this integration enables LLM 501 to support complex IT environments more effectively, aiding in design, implementation, troubleshooting, and optimization tasks with a high degree of reliability and expertise. According to various embodiments, the only enterprise data provided is selected, schematized telemetry data in particular table database table formats within GenDB 503.

According to various embodiments, a technique for implementing IT GenOps is provided. In particular embodiments, an IT administrator query is received through interface 505. According to various embodiments, upon receiving a query, LLM 501 determines the relevant sources and accesses telemetry data, including traces, log files, infrastructure configuration details, and alerts from disparate IT environments such as Dynatrace, Datadog, Google Cloud, AWS CloudWatch, and enterprise servers for analysis through data connector agent 513. In particular examples, this data is dynamically schematized into virtual tables within GenDB 503, allowing structured and flexible analysis. According to various embodiments, the system can fetch additional information as required to refine the insights. In certain implementations, Postgres Foreign Data Wrappers (FDWs) are used to seamlessly aggregate disparate data types into a unified schema within GenDB 503. In particular embodiments, this approach allows the user to interactively iterate with LLM 501 through SaaS 507 to arrive at practical and usable solutions.

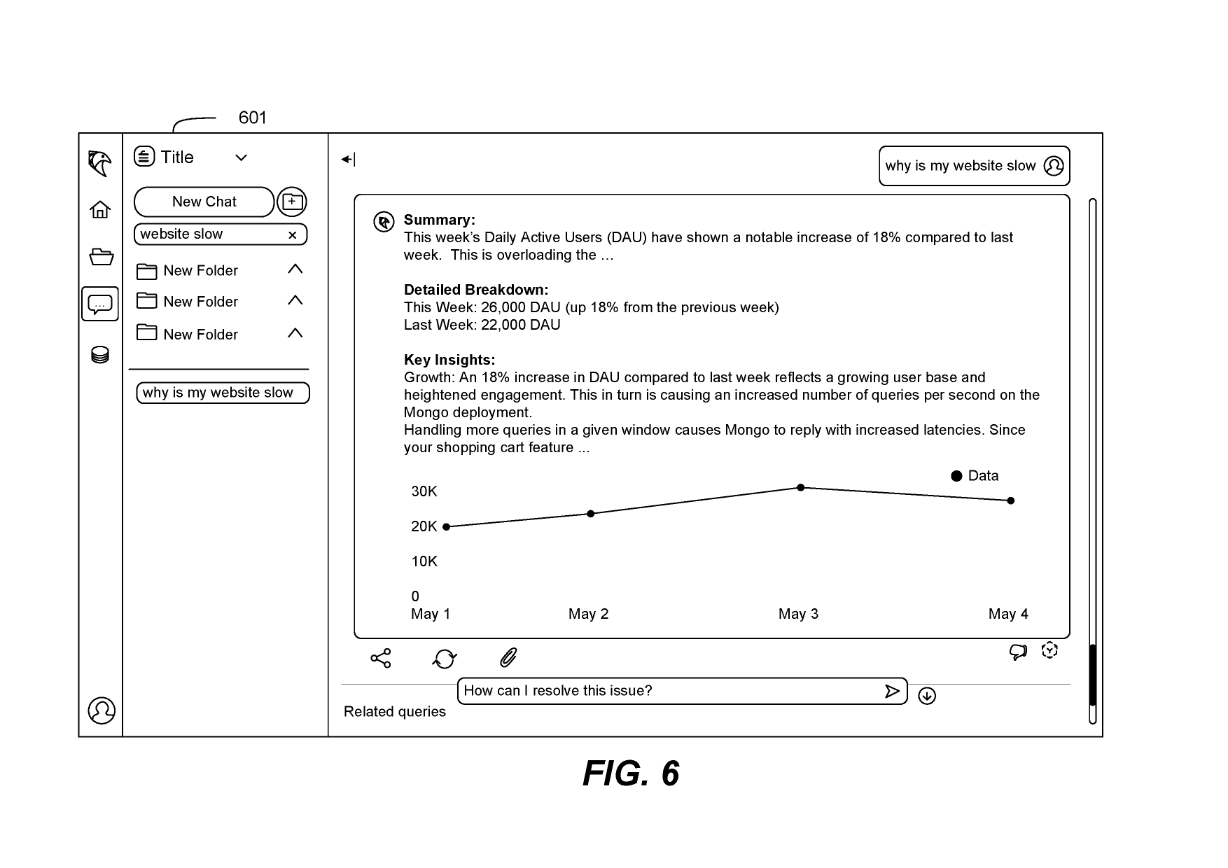

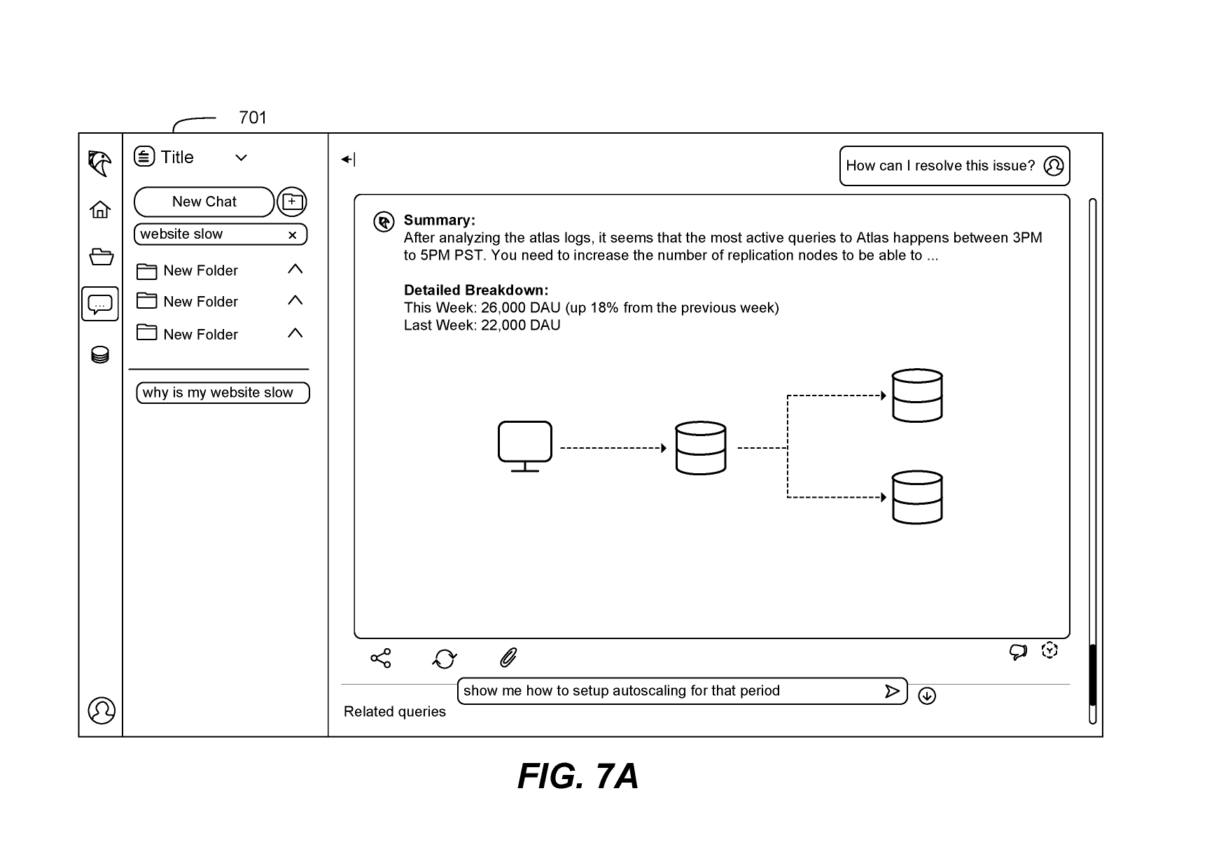

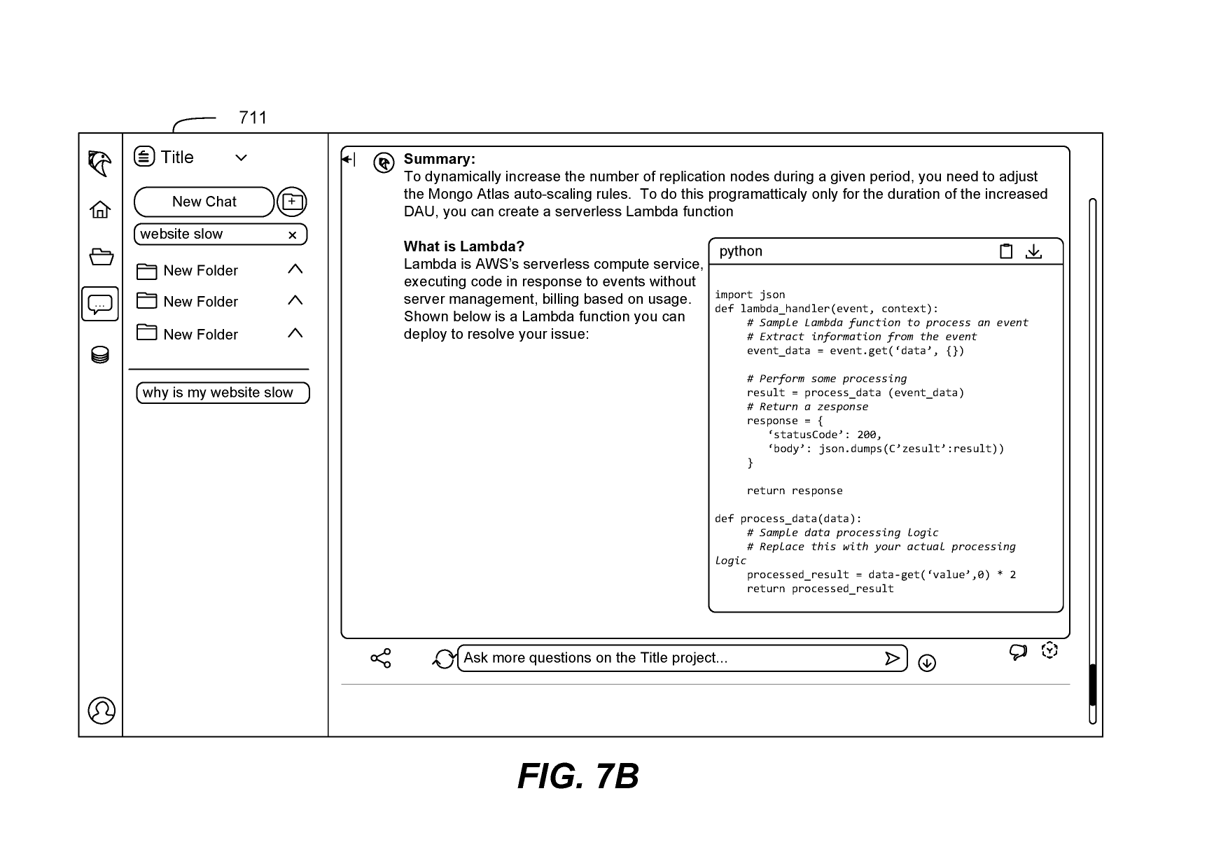

FIGS. 6, 7A, and FIG. 7B are diagrammatic representations illustrating examples of IT GenOps LLM user interfaces 601, 701, and 711. According to various embodiments, an IT GenOps user interface is designed to provide IT administrators with a seamless and intuitive platform for querying a structured Large Language Model (LLM) that utilizes a schematized database of telemetry data. In particular embodiments, a new chat button allows users to initiate a new query session. In particular embodiments, IT administrators can enter detailed questions about their IT environment.

According to various embodiments, a response area displays the results generated by the LLM. In particular embodiments, the response is organized into three distinct sections for clarity and comprehensiveness. The first section provides a summary of the findings, giving users a quick overview of the key points. The second section offers a detailed breakdown, presenting in-depth information extracted from the schematized telemetry data, including logs, metrics, alerts, and infrastructure configurations. This breakdown helps administrators understand the nuances of the response and the underlying data. The third section highlights key insights, which are actionable recommendations or critical observations derived from the analysis. This structured approach provides that IT administrators receive not only the raw data but also valuable context and guidance, empowering them to make informed decisions and efficiently manage their IT infrastructure. In particular embodiments, suggested solutions may include code to implement in order to resolve issues.

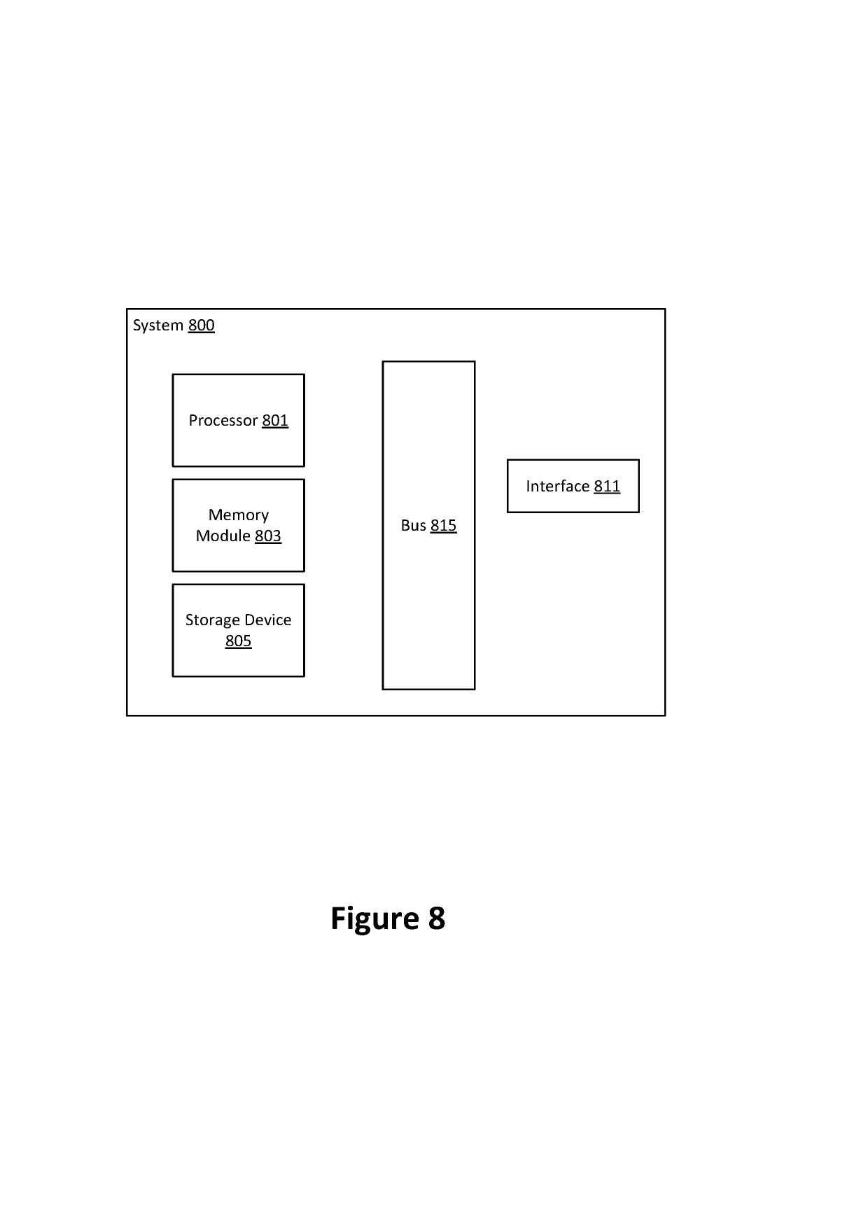

FIG. 8 illustrates one example of a computing device, configured in accordance with some embodiments. According to various embodiments, system 800 suitable for implementing embodiments described herein includes a processor 801, a memory module 803, a storage device 805, an interface 811, and a bus 815 (e.g., a PCI bus or other interconnection fabric.) System 800 may operate as variety of devices such as an application server, a web server, or any other device or service described herein. Although a particular configuration is described, a variety of alternative configurations are possible. The processor 801 may perform operations such as those described herein. Instructions for performing such operations may be embodied in the memory module 803, on one or more non-transitory computer readable media, or on some other storage device. Various specially configured devices can also be used in place of or in addition to the processor 801. The interface 811 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some implementations include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities. Accordingly, Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method, comprising:
continuously obtaining Information Technology (IT) telemetry data from a plurality of disparate IT platforms including a plurality of servers, network devices, and applications, the IT telemetry data associated with log files, system traces, metrics, alerts, and infrastructure configurations for monitoring and troubleshooting an enterprise IT system;
providing the IT telemetry data to a Large Language Model (LLM), the Large Language Model generating a plurality of schematic inferences from the IT telemetry data;
receiving an enterprise IT administrator query regarding the enterprise IT system;
generating a first plurality of subqueries using the enterprise IT administrator query and a plurality of query generation rules, the first plurality of subqueries including a first subquery, a second subquery, and a third subquery, wherein a first subquery response is generated by the LLM using the IT telemetry data, wherein the first subquery response triggers an update of an already generated second subquery, wherein the second subquery is modified based on an LLM generated response to the first subquery, wherein the first plurality of subqueries lead to generation of an LLM response to the enterprise IT administrator query.

2. The method of claim 1, wherein the IT telemetry data is used to generate an IT telemetry structured database used by the LLM.

3. The method of claim 1, wherein a plurality of alternate query generation rules are referenced to generate a plurality of alternate queries upon generation of the subqueries.

4. The method of claim 1, wherein a plurality of follow-on query generation rules are referenced to generate a plurality of follow-on queries upon generation of the subqueries.

5. The method of claim 1, wherein the plurality of subqueries are dynamically updated based on responses to previously executed subqueries.

6. The method of claim 1, wherein the IT telemetry data is dynamically schematized into virtual tables using Foreign Data Wrappers.

7. The method of claim 1, wherein the LLM is provided access only to IT manager specified data sources in a highly structured manner.

8. The method of claim 1, wherein the query generation rules include using only provided schemas and selecting only explicitly listed columns.

9. The method of claim 1, further comprising incorporating curated IT knowledge bases to reduce LLM hallucinations.

10. The method of claim 1, wherein the LLM connects to a customer VPC through a data connector agent without ETL processing.

11. A system, comprising:
a network interface configured to continuously obtaining Information Technology (IT) telemetry data from a plurality of disparate IT platforms including a plurality of servers, network devices, and applications, the IT telemetry data associated with log files, system traces, metrics, alerts, and infrastructure configurations for monitoring and troubleshooting an enterprise IT system, wherein the IT telemetry data is provided to a Large Language Model (LLM), the Large Language Model generating a plurality of schematic inferences from the IT telemetry data;
a processor configured to receive an enterprise IT administrator query regarding the enterprise IT system and generate a first plurality of subqueries using the enterprise IT administrator query and a plurality of query generation rules, the first plurality of subqueries including a first subquery, a second subquery, and a third subquery, wherein a first subquery response is generated by the LLM using the IT telemetry data, wherein the first subquery response triggers an update of an already generated second subquery, wherein the second subquery is modified based on an LLM generated response to the first subquery, wherein the first plurality of subqueries lead to generation of an LLM response to the enterprise IT administrator query.

12. The system of claim 11, wherein the IT telemetry data is used to generate an IT telemetry structured database used by the LLM.

13. The system of claim 11, wherein a plurality of alternate query generation rules are referenced to generate a plurality of alternate queries upon generation of the subqueries.

14. The system of claim 11, wherein a plurality of follow-on query generation rules are referenced to generate a plurality of follow-on queries upon generation of the subqueries.

15. The system of claim 11, wherein the plurality of subqueries are dynamically updated based on responses to previously executed subqueries.

16. The system of claim 11, wherein the IT telemetry data is dynamically schematized into virtual tables using Foreign Data Wrappers.

17. The system of claim 11, wherein the LLM is provided access only to IT manager specified data sources in a highly structured manner.

18. The system of claim 11, wherein the query generation rules include using only provided schemas and selecting only explicitly listed columns.

19. The system of claim 11, further comprising incorporating curated IT knowledge bases to reduce LLM hallucinations.

20. The system of claim 11, wherein the LLM connects to a customer VPC through a data connector agent without ETL processing.
